(19) United States
(12) Patent Application Publication
(10) Pub. No.: US 2007/0085377 A1
(43) Pub. Date: Apr. 19, 2007

(54) MODULAR WIND DEFLECTOR FOR A TRUCK

(75) Inventor: Mario BOUCHER, Tecumseh (CA)

Correspondence Address: DIMOCK STRATTON LLP, 20 QUEEN STREET WEST SUITE 3202, BOX 102, TORONTO, ON, M5H 3R3, CA

(73) Assignee: GLOBAL VEHICLE SYSTEMS INC., Tilbury (CA)

(21) Appl. No.: 11/550,183

(22) Filed: Oct. 17, 2006

(30) Foreign Application Priority Data
Oct. 18, 2005 (CA) 2,523,838

(51) Int. Cl. B62D 35/00

(52) U.S. Cl. 296/180.2

(57) ABSTRACT

A modular wind deflector is constructed from a plurality of wind deflecting panels. The panels include edge flanges for attaching adjacent panels together, which also form ribs on the inside of the wind deflector creating a substructure for resisting wind forces.

### FIELD OF THE INVENTION

This invention relates to truck accessories. In particular, this invention relates to a wind deflector for a semi-trailer truck cab.

### BACKGROUND OF THE INVENTION

A wind deflector is a device that changes the airflow around a vehicle. An effective wind deflector will reduce wind resistance while the vehicle is in motion, and consequently increases stability and fuel efficiency. Many types of vehicles use wind deflectors beneficially, but an effective wind deflector is especially advantageous in the heavy truck industry.

Semi-trailer trucks, also called “tractor-trailers,” are common in the heavy truck industry. The tractor, which includes a towing engine, is typically not as tall as the trailer, which carries the freight. The portion of the trailer extending above the roof of the tractor presents a large surface area which is vertical and perpendicular to the motion of the truck, and thus will be generally perpendicular to the flow of air when the truck is in motion at a high speed. Without a wind deflector, this configuration encounters considerable wind resistance from wind passing over the top of the tractor and hitting the vertical front face of the trailer.

Conventional wind deflectors are commonly manufactured from fiberglass as a single piece, which makes them unwieldy to ship to customers. A further disadvantage of a one piece wind deflector is that if part of it is damaged or shattered, for example by an airborne object, the entire wind deflector must be replaced. Further, once a mold is created for a wind deflector it can be used only for a specific shape and size of wind deflector, whereas different trucks may require different shapes or sizes of wind deflectors.

### BRIEF DESCRIPTION OF THE DRAWINGS

In drawings which illustrate by way of example only a preferred embodiment of the invention,

FIG. 1 is a side elevational view of the wind deflector;

FIG. 2 is a rear elevational view of the wind deflector shown in FIG. 1;

FIG. 3 is an elevational cross-section view of the wind deflector along the line 3-3 of FIG. 2;

FIG. 4 is an exploded view of the wind deflector of FIG. 1.

### DETAILED DESCRIPTION OF THE INVENTION

The present invention provides a wind deflector which is constructed from detachably attached pieces. The invention thus facilitates shipping of the wind deflector, because it can be packaged more compactly. In addition, if a portion of the wind deflector is shattered or damaged, the wind deflector may be repaired by replacing the damaged portion of the wind deflector, as opposed to replacing the entire wind deflector as must be done with a conventional, unitary wind deflector. Also, the molds used to make at least some of the modular components of a wind deflector of the invention can be used for other wind deflectors of different shapes and sizes, by combining modular components from one design with modular components of other designs.

The preferred embodiment is accomplished by providing a wind deflector comprising a plurality of modular panels which are affixed together to create a wind deflector of the desired size and configuration. In the preferred embodiment, the panels are each provided with edge flanges which depend rearwardly and attach to complementary flanges of adjacent panels, to both hold the components of the wind deflector securely together and form strengthening ribs that provide a strong, rigid substructure which resists the wind forces imparted to the wind deflector when in use.

Because its components are of a much smaller size than the wind deflector itself, the invented wind deflector can be injection molded rather than constructed from fiberglass. This allows for a much wider choice of materials for the wind deflector, and thus allows for the construction of wind deflectors having more favourable strength and durability characteristics than fiberglass permits.

Additionally, companies that own a fleet of trucks often brand the wind deflector with the company name and/or logo, or other desired indicia. The modular design of the invented wind deflector allows for many of the same components to be used for many different companies, changing only one of the components which carries the brand or indicia for each particular company.

In the preferred embodiment the edge flanges are generally orthogonal to the deflecting surface of the panel, to maximize resistance to wind forces, although the edge flanges may be at any desired angle relative to the deflecting surface of the panel. The adjacent panels are preferably detachably affixed together in order to provide all the advantages of the invention, although even if permanently affixed together the resulting wind deflector will provide the advantages of reduced shipping cost, and versatility in available materials, manufacturing methods and the use in wind deflectors of different sizes and shapes.

The invention thus provides a wind deflector for a truck having a tractor and a trailer, a front face of the trailer extending above a roof of the tractor, the wind deflector comprising a plurality of panels, each panel comprising a wind deflecting front face and at least one attachment member associated with at least one edge of the panel, such that when adjacent attachment members of adjacent panels are affixed together the adjacent panels are affixed together in substantially abutting relation.

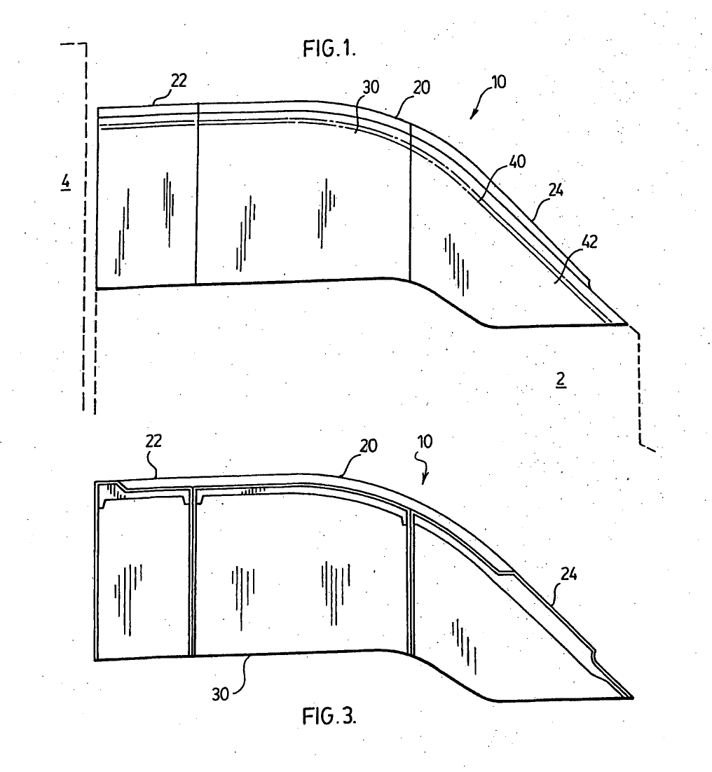

FIGS. 1 to 3 illustrate a preferred embodiment of a wind deflector according to the invention. The wind deflector 10 is shown atop a tractor 2 that tows a trailer 4. The preferred embodiment of the invention is most advantageously used with tractor-trailers, but it will be appreciated that the invention can be configured in different shapes and sizes and thus can also be used beneficially with other vehicles.

The wind deflector 10 is mounted to the roof of the tractor 2, in any suitable fashion, so as to extend upwardly from the roof of the tractor 2, and is preferably configured and oriented to form an aerodynamically efficient continuation of the outer surfaces of the tractor 2, as is conventional. The rear end of wind deflector 10 is preferably as high as the top of the trailer, although it may be higher if height restrictions and limitations (e.g. bridges) permit.

In the embodiment shown the front portion 20 includes a flat portion 22 and a sloping portion 24 that slopes downwards towards the front of tractor 2 at an angle of approximately 45 degrees from the top surface of the tractor 2. It will be appreciated that different slopes may be employed for the sloping portion 24, which will change the lengths of the flat portion 22 and the sloping portion 24. The side portions 30 slope inwards from above the side faces at rear end of the tractor 2 at an angle of approximately 15 degrees, although it will be appreciated that other slopes may be used beneficially. The combination of the front portion 20 and the side portions 30 deflect wind over the top and around the sides of the trailer 4 when the tractor-trailer is in motion.

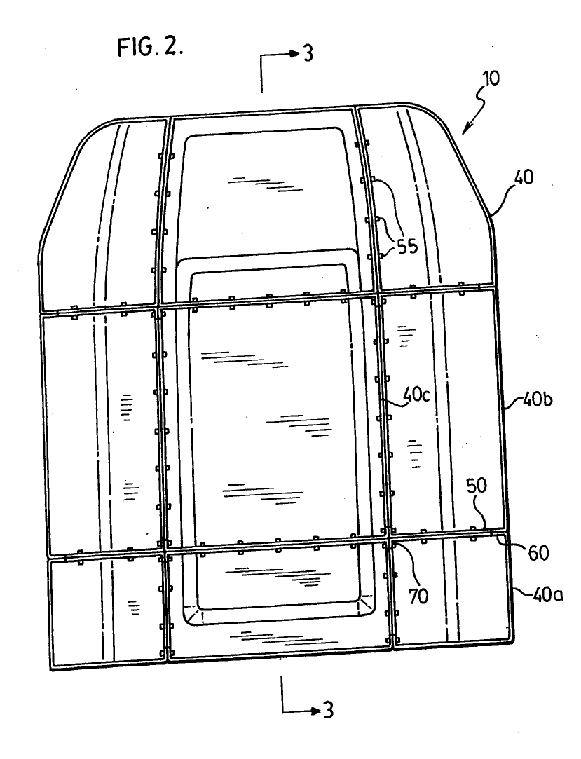

The wind deflector 10 is constructed from a plurality of panels 40. The wind deflector 10 shown in FIG. 2 comprises nine panels 40 attached together. Other embodiments may consist of more or less panels 40, as desired.

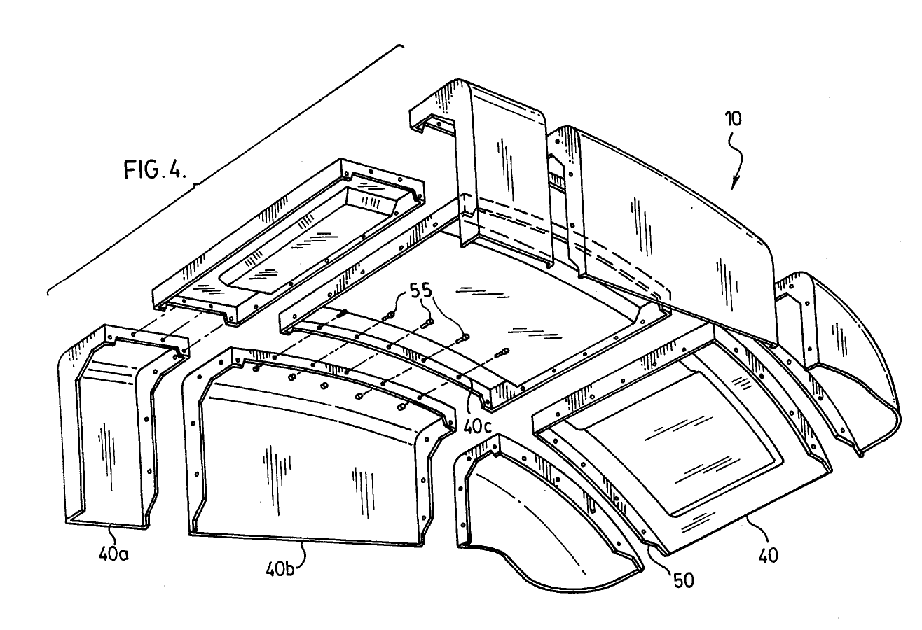

Each panel 40 includes a wind deflecting front surface 42 and at least one attachment member 50, for example an edge flange depending rearwardly from the panel 40. The number of edge flanges 50 will depend upon the position of the panel 40 within the wind deflector 10, there being one edge flange 50 for each adjacent panel: thus, as shown in FIG. 4, a corner panel 40a will have only two edge flanges 50 whereas a side panel 40b will have three edge flanges 50 and a centre panel 40c will have four edge flanges 50. In the embodiment shown the edge flanges 50 depend generally orthogonally relative to the deflecting surface 42 of the panel, to maximize resistance to wind forces. Preferably each edge flange 50 extends along the full length of the edge of the deflecting surface 42, although this is desirable for strength but not strictly necessary. Each edge flange 50 is wide enough and thick enough to accept a bolt 55 or other fastening member without tearing or permanently deforming during use of the wind deflector 10. A plurality of bolts 55 or other fastening members are preferably evenly spaced along each edge flange 50, to minimize relative motion between panels during use of the wind deflector 10.

The panels 40 may be made from a wide range of materials, including metals (particularly aluminum), plastic or fiberglass, or a combination thereof. Aluminum wind deflectors are both lightweight and durable. Acrylic wind deflectors are commonly manufactured with an aluminum frame, with the outer shell being thermoformed of color-impregnated, scratch-resistant plastic that is conditioned to fend off weather and ultraviolet (UV) rays. Fiberglass wind deflectors can also be built over a metal frame. The panels 40 are preferably formed from plastic by injection molding, so as to achieve the desired aerodynamic styling for each individual surface piece 40 and a strength, rigidity and weather-resistance suitable for a wind deflector 10.

In use, the wind deflector 10 is constructed by attaching the edge flanges 50 of each panel 40 to the edge flanges 50 of each adjacent panel 40. The attached flanges 50 are preferably bolted together so as to be detachable, but may alternatively be permanently attached by resin or epoxy, rivets, clips or any other suitable means. The attached edge flanges 50 form ribs 60 along the rear face of the wind deflector 10, creating a strong substructure 70 for resisting wind forces.

Various embodiments of the present invention having been thus described in detail by way of example, it will be apparent to those skilled in the art that variations and modifications may be made without departing from the invention. The invention includes all such variations and modifications as fall within the scope of the appended claims.

I claim:

1. A wind deflector for a truck having a tractor and a trailer, a front face of the trailer extending above a roof of the tractor, the wind deflector comprising a plurality of panels, each panel comprising a wind deflecting front face and at least one attachment member associated with at least one edge of the panel, such that when adjacent attachment members of adjacent panels are affixed together the adjacent panels are affixed together in substantially abutting relation.

2. The wind deflector of claim 1, wherein the attachment member is a flange depending rearwardly from the edge of the panel, adjacent flanges of adjacent panels being complementary.

3. The wind deflector of claim 2, wherein the flange depends rearwardly from the edge of the panel at approximately right angles.

4. The wind deflector of claim 3, wherein the flange extends along the full length of the edge of the panel.

5. The wind deflector of claim 1, wherein the panels are formed from plastic by injection molding.

6. The wind deflector of claim 1, wherein the plurality of panels is at least three panels.

7. The wind deflector of claim 1, wherein the plurality of panels is three panels.

8. A method of constructing a wind deflector from a plurality of wind deflecting panels each comprising attachment members for attaching a panel to at least one adjacent panel, comprising the steps of:
a. aligning the plurality of wind deflecting panels together such that each panel is in substantially abutting relation with at least one other panel and adjacent panels have adjacent attachment members in substantially abutting relation; and
b. affixing the adjacent attachment members together to form the wind deflector.

9. The method of claim 8, further comprising, before step a., the step of forming a plurality of wind deflecting panels from plastic by injection molding.

10. The method of claim 8, wherein the plurality of wind deflecting panels comprises a row of at least three panels.

11. The method of claim 10, wherein the plurality of wind deflecting panels comprises a row of three panels.
